(19) United States
(12) Patent Application Publication
(10) Pub. No.: US 2025/0379013 A1
(43) Pub. Date: Dec. 11, 2025

(54) LEVER AND INPUT DEVICE

(71) Applicant: AAC Technologies Pte. Ltd., Singapore (SG)

(72) Inventor: Kazuo Shikama, Osaka (JP)

(21) Appl. No.: 19/001,636

(22) Filed: Dec. 26, 2024

(30) Foreign Application Priority Data
Jun. 7, 2024 (JP) 2024093355

(51) Int. Cl. H01H 21/24; H01H 21/04

(52) U.S. Cl. CPC H01H 21/24; H01H 21/04

(57) ABSTRACT

A lever includes a shell, a movable component, a position detection component and a magnetic reset component. The shell is provided with an accommodating chamber. The movable component is arranged in the accommodating chamber and is partially threaded out of the shell. The position detection component is arranged in the accommodating chamber and is configured to: detect displacement information of the movable component and output a corresponding first control signal. The magnetic reset component includes a first magnetic attraction member and a second magnetic attraction member. One of the first magnetic attraction member and the second magnetic attraction member is arranged in the shell. Compared with a method for resetting the movable component by using a physical spring, the present application can eliminate the problem of damage to the physical spring caused by vibration and a falling impact of the movable component, and prolong the life of the lever.

### CROSS-REFERENCE TO RELATED APPLICATIONS

This application claims a priority benefit of a Japanese patent application No. JP 2024-093355 filed on Jun. 7, 2024, which is incorporated herein by reference in its entireties.

### TECHNICAL FIELD

The present application relates to the technical field of electronic equipment, and in particular, to a lever for electronic equipment and an input device with the lever.

### BACKGROUND

With the development of electronic technology, electronic products attract more and more attentions. For example, electronic products such as a portable game console, a fixed game console, a vehicle-mounted device, industrial operating equipment, and portable multimedia entertainment equipment may often use levers to smoothly feed back inputs of users to systems such as a controller for the portable game console, a controller for the fixed game console, a controller for the vehicle-mounted device, a controller for the industrial operating equipment, and a controller for the portable multimedia entertainment equipment.

An existing lever usually uses a compression spring to reset a main shaft. However, this method may possibly easily damage the compression spring due to a falling impact of the main shaft, reciprocating motion and vibration caused by repeated inputting performed by a user, and the like, thus affecting the life of the lever.

### SUMMARY

To overcome the above problems in the related art, a main objective of the present application is to provide a lever with prolonged life, an input device and a magnetic reset component.

In order to achieve the above object, the technical scheme according to the present disclosure is as follows.

The present disclosure provides a lever. The lever includes a shell, a movable component, a movable component and a position detection component.

The shell is provided with an accommodating chamber.

The movable component is arranged in the accommodating chamber and is partially threaded out of the shell.

The position detection component is arranged in the accommodating chamber and is configured to: detect displacement information of the movable component and output a corresponding first control signal.

The magnetic reset component includes a first magnetic attraction member and a second magnetic attraction member; one of the first magnetic attraction member and the second magnetic attraction member is arranged in the shell; the other one of the first magnetic attraction member and the second magnetic attraction member is arranged in the movable component; and the first magnetic attraction member and the second magnetic attraction member are able to attract each other.

In some embodiments, the first magnetic attraction component is a magnet, and the second magnetic attraction component is a magnet sheet.

In some embodiments, the position detection component includes a position detection element and a circuit board; the circuit board is arranged in the accommodating chamber and is partially threaded out of the shell; the position detection element is connected to the circuit board; the position detection element is configured to detect the displacement information of the movable component; and the circuit board is configured to convert the displacement information into the first control signal and output the first control signal.

In some embodiments, the coil is connected to the circuit board and is located between the first magnetic attraction member and the second magnetic attraction member.

In some embodiments, the magnet sheet is arranged on an inner wall of the shell; the circuit board is arranged on the shell and covers the magnet sheet; the position detection element and the coil are located on one side of the circuit board facing away from the magnet sheet; and the magnet is arranged on the movable component.

In some embodiments, the shell includes a bottom shell and an upper shell; the upper shell and the bottom shell are connected to form the accommodating chamber;

the lever further includes a switch element; the switch element is arranged on the bottom shell; the movable component is rotatably connected to the upper shell, and the movable component cooperates with the switch element; and the switch element is configured to output a second control signal when the movable component pushes the switch element.

In some embodiments, the movable component includes a moving part, a main shaft, a secondary shaft, and a guide part; the moving part is movably arranged in the accommodating chamber;

the secondary shaft and the guide part are respectively arranged in the accommodating chamber, and the secondary shaft is movably connected to the moving part and the upper shell respectively; the guide part is movably connected to the moving part and the upper shell respectively; one end of the main shaft is connected to the secondary shaft, and the other end of the main shaft passes through the secondary shaft and the guide part in sequence and is threaded out of the upper shell; the magnet sheet and the circuit board are respectively arranged on an inner wall of the bottom shell; and the magnet is arranged on the moving part.

In some embodiments, the bottom shell is provided with a first receiving slot; the magnet sheet is arranged in the first receiving slot; the moving part is provided with a second receiving slot on one side facing the circuit board; and the magnet is arranged in the second receiving slot.

In some embodiments, the bottom shell is provided with a plurality of first limiting slots; the movable component further includes a plurality of bearings; the plurality of bearings are respectively arranged in the plurality of first limiting slots; and a lower surface of the moving part is in contact with the plurality of bearings.

In some embodiments, the switch element is located on an outer side of the accommodating chamber; and the secondary shaft is partially threaded out of the outer side of the accommodating chamber and is located above the switch element.

In some embodiments, the movable component includes a main shaft, a secondary shaft, and a guide part; the secondary shaft and the guide part are respectively arranged in the accommodating chamber, and the secondary shaft is movably connected to the upper shell; the guide part is movably connected to the upper shell; one end of the main shaft is connected to the secondary shaft, and the other end of the main shaft passes through the secondary shaft and the guide part in sequence and is threaded out of the upper shell; the magnet sheet and the circuit board are respectively arranged on an inner wall of the upper shell; and the magnet is arranged on the secondary shaft and the guide part.

In some embodiments, the secondary shaft is provided with a first receiving chamber; the guide part is provided with a second receiving chamber; the magnet is accommodated in the first receiving chamber and the second receiving chamber.

In some embodiments, the switch element is located in the accommodating chamber, and the secondary shaft is located above the switch element.

In some embodiments, the secondary shaft is provided with a first guide slot; the guide part is provided with a second guide slot; the first guide slot and the second guide slot are arranged crosswise; one end of the main shaft is connected to the secondary shaft, and the other end of the main shaft is threaded out of the upper shell after passing through the first guide slot and the second guide slot in sequence.

The present disclosure further provides an input device, including a device body and a lever described above, the lever is mounted on the device body.

Compared with the related art, The present disclosure provides a lever. The lever includes a shell, a movable component, a position detection component and a magnetic reset component. The shell is provided with an accommodating chamber. The movable component is arranged in the accommodating chamber and is partially threaded out of the shell. The position detection component is arranged in the accommodating chamber and is configured to: detect displacement information of the movable component and output a corresponding first control signal. The magnetic reset component includes a first magnetic attraction member and a second magnetic attraction member; one of the first magnetic attraction member and the second magnetic attraction member is arranged in the shell; the other one of the first magnetic attraction member and the second magnetic attraction member is arranged in the movable component; and the first magnetic attraction member and the second magnetic attraction member are able to attract each other. This embodiment can reset the movable component by using the mutual attraction between the first magnetic attraction member and the second magnetic attraction member. Compared with a method for resetting the movable component by using a physical spring, the present application can eliminate the problem of damage to the physical spring caused by vibration and a falling impact of the movable component, and prolong the life of the lever.

### BRIEF DESCRIPTION OF THE DRAWINGS

FIG. 1 is a three-dimensional diagram of a lever according to an embodiment of the present application.

FIG. 2 is a three-dimensional exploded diagram of a lever according to an embodiment of the present application.

FIG. 3 is another three-dimensional exploded diagram of a lever according to an embodiment of the present application.

FIG. 4 is a three-dimensional diagram of a bottom shell in FIG. 3.

FIG. 5 is a three-dimensional diagram of a moving part in FIG. 3.

FIG. 6 is a three-dimensional diagram of an upper shell in FIG. 3.

FIG. 7 is a three-dimensional diagram of a secondary shaft and a guide part in FIG. 3.

FIG. 8 is a three-dimensional diagram of a moving part in FIG. 3, viewed from another viewing angle.

FIG. 9 is a three-dimensional diagram of a lever according to another embodiment of the present application.

FIG. 10 is a three-dimensional exploded diagram of a lever according to another embodiment of the present application.

FIG. 11 is another three-dimensional exploded diagram of a lever according to another embodiment of the present application.

FIG. 12 is a three-dimensional diagram of a secondary shaft and a guide part in FIG. 11.

FIG. 13 is a three-dimensional diagram of an input device according to an embodiment of the present application.

FIG. 14 is a three-dimensional diagram of another input device according to an embodiment of the present application.

### DETAILED DESCRIPTION OF THE EMBODIMENTS

In order to make the aims, technical solution and advantages of the present disclosure will be clearly, the present disclosure is further described below in combination with accompanying drawings and implementations. It should be understood that the specific embodiments described herein are intended only to explain the present disclosure and are not intended to define the present disclosure.

In the present disclosure, unless specific regulation and limitation otherwise, the terms “first” and “second” are used for descriptive purposes only, while not to be construed as indicating or implying relative importance.

Unless otherwise indicated, the terms “multiple” means two or more.

The terms “connected” and “fixed” are to be construed broadly, For example, it can be a fixed connection, a detachable connection, an integral structure, an electrical connection, a direct connection, an indirect connection through an intermediate medium, or a communication between two devices, elements or components. For ordinary technical personnel in this field, the specific meanings of the above terms in present disclosure can be understood based on specific circumstances.

In the description of the present disclosure, It is to be understood that, the directional terms such as “above”, and “below” described in the embodiments of the present disclosure are described from the angles shown in the drawings, and should not be construed as limiting the embodiments of the present disclosure. In addition, in this context, it should also be understood that when an element is referred to as being “above” or “below” another element, it can not only be directly connected “above” or “below” another element, but also indirectly connected to the “above” or “below” of another element through an intermediate.

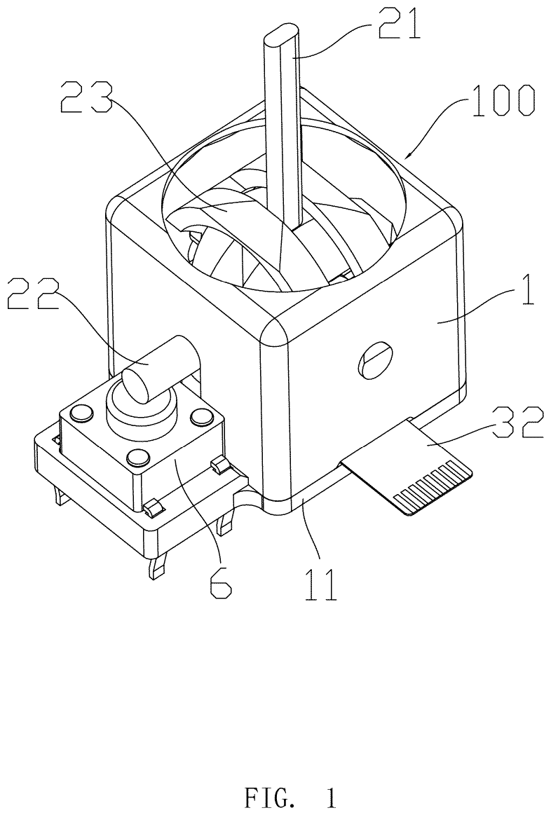

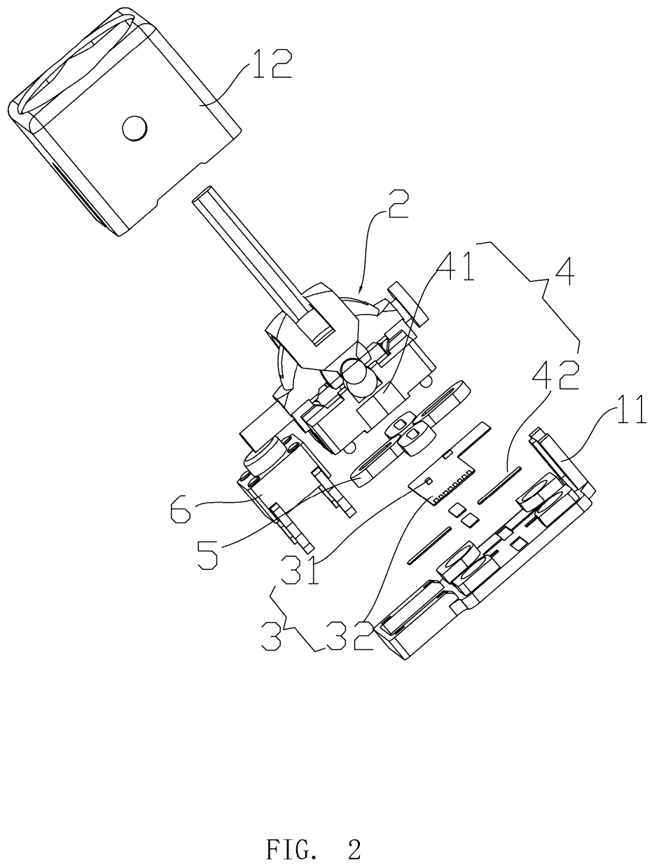

Referring to FIG. 1 and FIG. 2, an embodiment of the present application discloses a lever 100. The lever 100 includes a shell 1, a movable component 2, a position detection component 3, a magnetic reset component 4, and a switch element 6. The shell 1 includes a bottom shell 11 and an upper shell 12. The upper shell 12 and the bottom shell 11 are connected to form an accommodating chamber. The movable component 2 is arranged in the accommodating chamber formed by the bottom shell 11 and the upper shell 12. The movable component 2 is rotatably connected to the upper shell 12. The movable component 2 is partially threaded out of the upper shell 12. The position detection component 3 is arranged in the accommodating chamber and is configured to: detect displacement information of the movable component 2 and output a corresponding first control signal. The magnetic reset component 4 is arranged in the accommodating chamber and is configured to reset the movable component 2. Namely, the movable component 2 can be restored to its initial position through the magnetic reset component 4. The initial position is a position where the movable component 2 is not operated. The switch element 6 is arranged in the shell 1. The control element 6 cooperates with the movable component 2. When the movable component 2 pushes the switch element 6, the switch element 6 can output a corresponding second control signal. The first control signal and the second control signal can be configured to control a virtual character of a game. For example, the first control signal can be configured to control a motion direction of the virtual character of the game, and the second control signal can be configured to control start of the game.

During operation, a user can operate the movable component 2 to enable the movable component 2 to move, and then, the position detection component 3 detects the displacement information of the movable component 2 and outputs the corresponding first control signal. Next, the movable component 2 is reset through the magnetic reset component 4, or the user can press the movable component 2 to enable the movable component 2 to push the switch element 6, so that the switch element 6 can output the second control signal.

In this embodiment, the magnetic reset component 4 includes a first magnetic attraction member and a second magnetic attraction member. One of the first magnetic attraction member and the second magnetic attraction member can be arranged in the shell 1, and the other one of the first magnetic attraction member and the second magnetic attraction member can be arranged in the movable component 2. The first magnetic attraction member and the second magnetic attraction member can attract each other, so that the movable component 2 can be reset through the mutual attraction between the first magnetic attraction member and the second magnetic attraction member. Exemplarily, the first magnetic attraction component is a magnet 41, and the second magnetic attraction component is a magnet sheet 42. This embodiment can reset the movable component 2 by using the mutual attraction between the first magnetic attraction member and the second magnetic attraction member, instead of using a physical spring. The present application can eliminate the problem of damage to the physical spring caused by vibration and a falling impact of the movable component, and prolong the life of the lever 100.

Continuing to refer to FIG. 2, the lever 100 further includes a coil 5. The position detection component 3 includes a position detection element 31 and a circuit board 32. The circuit board 32 can be a flexible printed substrate. The coil 5 and the position detection element 31 are respectively electrically connected to the circuit board 32. During assembling, the movable component 2 can be rotatably connected to the upper shell 12. The magnet 41 is arranged on the movable component 2. The switch element 6 is arranged on the bottom shell 11. The magnet sheet 42 is arranged on an inner wall of the shell 1, and the circuit board 32 connected with the position detection element 31 and the coil 5 is arranged on the inner wall of the shell 1 and covers the magnet sheet 42. The position detection element 31 and the coil 5 are located on one side of the circuit board 32 facing away from the magnet sheet 42. Afterwards, the upper shell 12 and the bottom shell 11 are connected to each other, so that the coil 5 is located between the magnet 41 and the magnet sheet 42. The movable component 2 and the switch element 6 cooperate with each other to output the second control signal through the switch element 6 when the movable component 2 pushes the switch element 6. The position detection element 31 is configured to detect the displacement information of the movable component 2. The circuit board 32 is configured to: convert the displacement information into the first control signal and output the first control signal, and the coil 5 is configured to generate Lorentz force on the magnet 41.

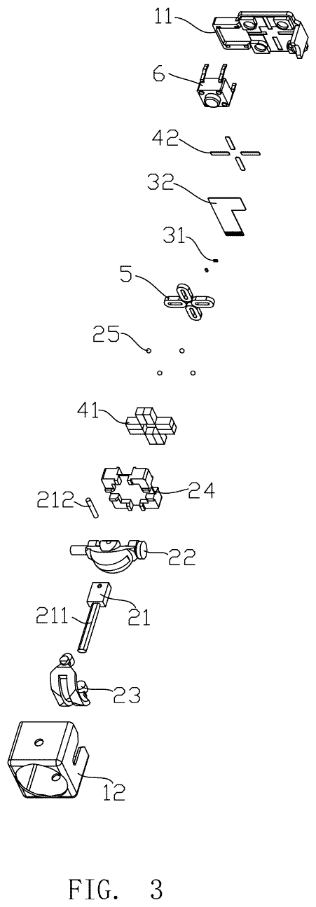

Referring to FIG. 3, the movable component 2 includes a moving part 24, a main shaft 21, a secondary shaft 22, and a guide part 23. During assembling, the magnet sheet 42 can be arranged on an inner side of the bottom shell 11. The circuit board 32 is arranged on the bottom shell 11 and covers the magnet sheet 42. The magnet 41 is arranged on the moving part 24. The moving part 24 is movably arranged in the accommodating chamber formed by the upper shell 12 and the bottom shell 11. The secondary shaft 22 and guide part 23 are respectively arranged in the accommodating chamber, and the moving part 24, the secondary shaft 22, and the guide part 23 are arranged in sequence in a height extension direction of the shell 1. Meanwhile, the secondary shaft 22 is movably connected to the moving part 24 and the upper shell 12 respectively, and the secondary shaft 22 is at least partially located on an upper surface of the switch element 6. The guide part 23 is movably connected to the moving part 24 and the upper shell 12 respectively. One end of the main shaft 21 is connected to the secondary shaft 22, and the other end of the main shaft 21 is threaded out of the secondary shaft 22 and the guide part 23 in sequence and is threaded out of the upper shell 12.

In this embodiment, the switch element 6 is located on an outer side of the accommodating chamber. The secondary shaft 22 is partially threaded out of the outer side of the accommodating chamber and is in contact with the upper surface of the switch element 6.

Exemplarily, when the user operates the main shaft 21 to move in left, right, front, and rear directions, the main shaft 21 can drive the moving part 24 to move in the left and right directions through the secondary shaft 22, or the main shaft 21 can drive the moving part 24 to move in the front and rear directions through the guide part 23, thereby driving the magnet 41 to move in all the directions. In this case, the position detection element 31 can detect a moving direction of the magnet 41, and then convert the moving direction of the magnet 41 into a corresponding control signal through the circuit board 32 and transmit the control signal to external equipment (such as a computer). Meanwhile, when required, the main shaft 21 can be pushed, and a force on the main shaft 21 is transmitted to the switch element 6 through the secondary shaft 22, so that the switch element 6 outputs the corresponding signal after being pushed. In addition, electric energy can be provided to the coil 5 through a voice coil motor, so that the coil 5 can generate the Lorentz force on the magnet 41, namely, generate a reaction force on the moving part 24. The reaction force can be transmitted through the secondary shaft 22 and the guide part 23.

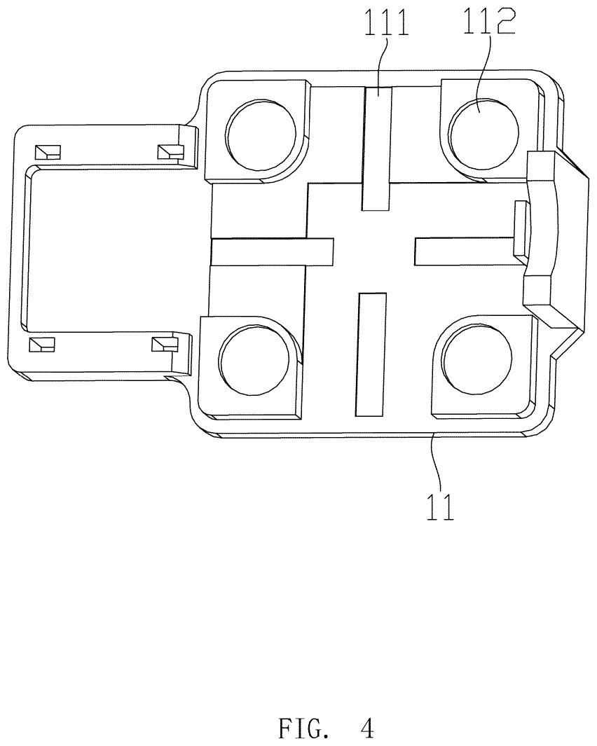

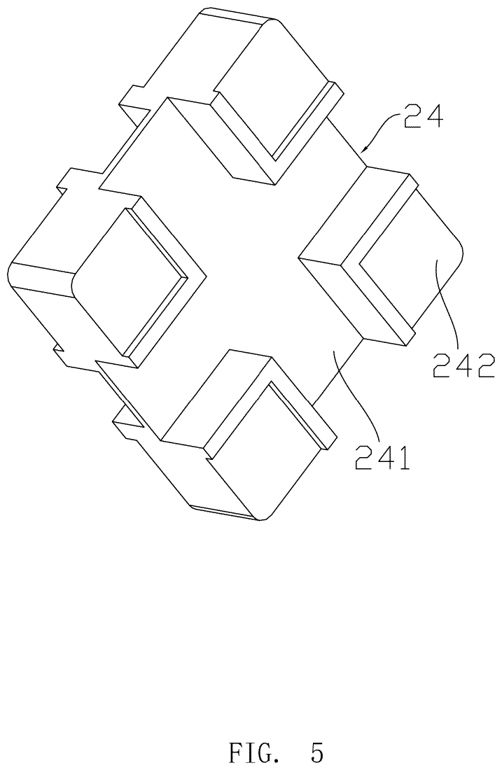

Referring to FIG. 4 and FIG. 5, the movable component 2 further includes a plurality of bearings 25 (shown in FIG. 3). A plurality of first receiving slots 111 and a plurality of first limiting slots 112 are provided in the inner side of the bottom shell 11. The moving part 24 is provided with a plurality of second receiving slots 241 and a plurality of second limiting slots 242 on one side facing the circuit board 32. Positions of the second receiving slots 241 and positions of the first receiving slots 111 are in one-to-one correspondence, and positions of the second limiting slots 242 and positions of the first limiting slots 112 are in one-to-one correspondence. During assembling, a plurality of magnet sheets 42 can be respectively arranged in the first receiving slots 111. A plurality of magnets 41 are respectively arranged in the second receiving slots 241. The plurality of bearings 25 are respectively arranged in the plurality of first limiting slots 112, and surfaces of the plurality of bearings 25 are in contact with the inner walls of the second limiting slots 242. In this embodiment, a magnetic spring effect can be achieved by allowing the magnets 41 and the magnet sheets 42 to attract each other, thereby generating a reaction force that can enable the main shaft 21 to return to its initial position. Meanwhile, the bearings 25 are arranged between the bottom shell 11 and the moving part 24, so that sliding between the moving part 24 and the bottom shell 11 can be smoother, and wear and failures caused by the interaction between the main shaft 21 and the upper shell 12 during the movement can be reduced.

In some embodiments, the magnet sheets 42 can be arranged the second receiving slots 241, and the magnets 41 can be arranged in the first receiving slots 111. In this case, the magnets 41 and the magnet sheets 42 can attract each other, thereby achieving a magnetic spring effect and generating a reaction force that can enable the main shaft 21 to return to its initial position. Of course, the position detection element 31 and the circuit board 32 can be arranged on the moving part 24. In this case, relative movements of the magnets 41 can be detected through the position detection element 31, and the circuit board 32 outputs a corresponding signal to external equipment.

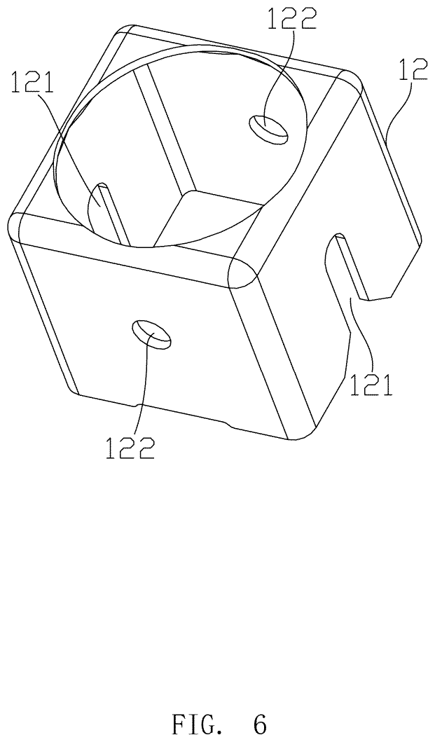

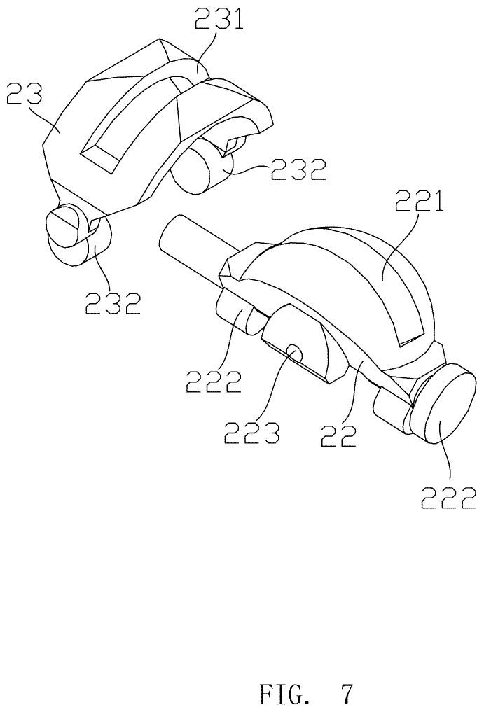

Referring to FIG. 6 and FIG. 7, the upper shell 12 is provided with a first embedding portion 121 and a second embedding portion 122. The secondary shaft 22 is provided with a third embedding portion 222 and a fourth embedding portion 223. The guide part 23 is provided with a fifth embedding portion 232, and the main shaft 21 includes a control shaft 211 (shown in FIG. 3) and a connecting shaft 212 (shown in FIG. 3). During assembling, the connecting shaft 212 passes through the fourth embedding portion 223 of the control shaft 211 and the secondary shaft 22, so that one end of the control shaft 211 is connected to the secondary shaft 22, and the other end of the control shaft 211 is threaded out of the secondary shaft 22 and the guide part 23 in sequence, thereby achieving rotatable connection between the main shaft 21 and the secondary shaft 22. Then, the third embedding portion 222 of the secondary shaft 22 is movably connected to the first embedding portion 121 of the upper shell 12, and the fifth embedding portion 232 of the guide part 23 is movably connected to the second embedding portion 122 of the upper shell 12, so that the secondary shaft 22 and the guide part 23 are respectively movably connected to the upper shell 12, and the secondary shaft 22 and the guide part 23 can be mounted in an embedded manner.

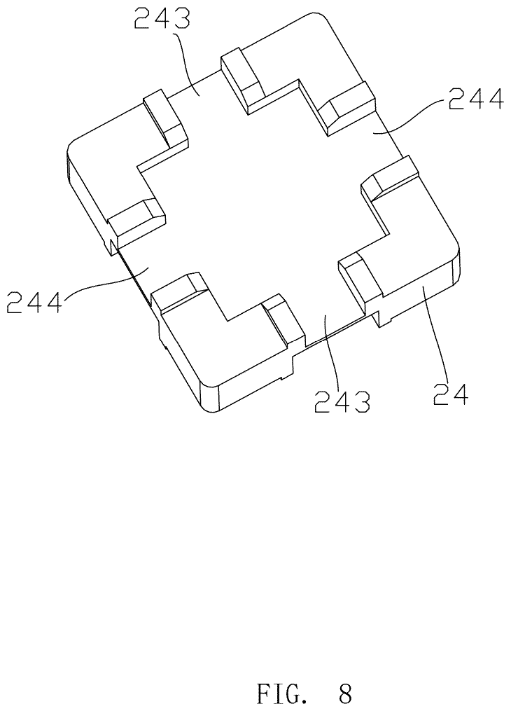

Referring to FIG. 8, a first embedding slot 243 and a second embedding slot 244 are provided in one side of the moving part 24 facing away from the circuit board 32. The third embedding portion 222 of the secondary shaft 22 further cooperates with the first embedding slot 243 of the moving part 24 for limitation. The fifth embedding portion 232 of the guide part 23 further cooperates with the second embedding slot 244 of the moving part 24 for limitation, so that during rotation, the secondary shaft 22 or the guide part 23 can drive the moving part 24 to move. Exemplarily, when the main shaft 21 is operated to move, a force applied to the main shaft 21 may be transmitted to the moving part 24 through the guide part 23 and the secondary shaft 22, so that the main shaft 21 can drive the secondary shaft 22 or the guide part 23 to move, thereby driving the moving part 24 to slide freely on a plane. The moving part 24 can also be transmitted to the main shaft 21 via the secondary shaft 22 and the guide part 23 due to the reaction force caused by the coil 5.

Continuing to refer to FIG. 7, the secondary shaft 22 is provided with a first guide slot 221, and the guide part 23 is provided with a second guide slot 231. During assembling, the first guide slot 221 and the second guide slot 231 are arranged crosswise. One end of the main shaft 21 is connected to the secondary shaft 22, and the other end of the main shaft 21 is threaded out of the upper shell 12 after passing through the first guide slot 221 and the second guide slot 231 in sequence for operation by the user.

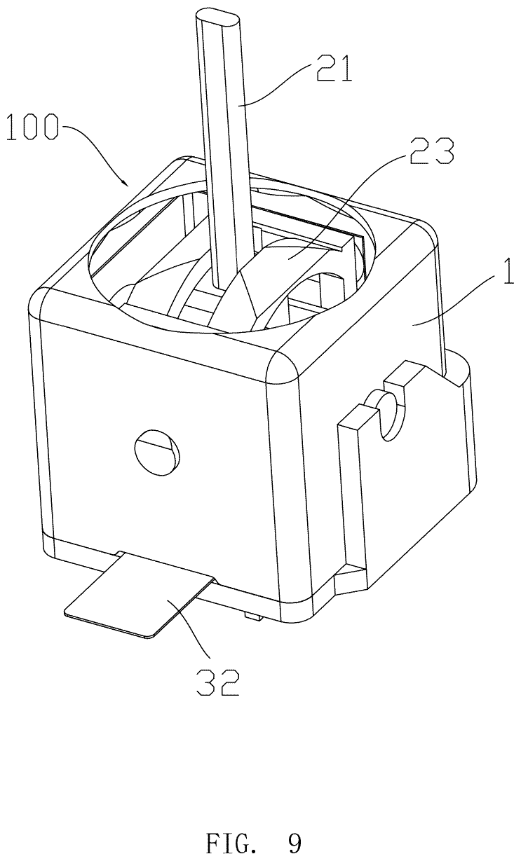

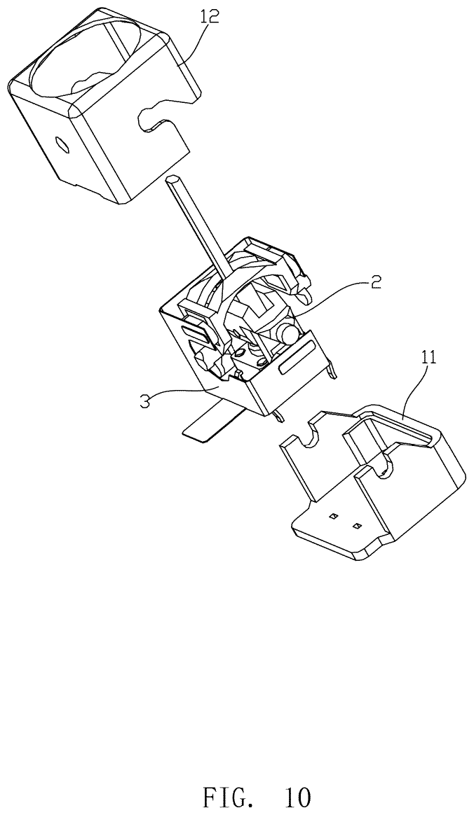

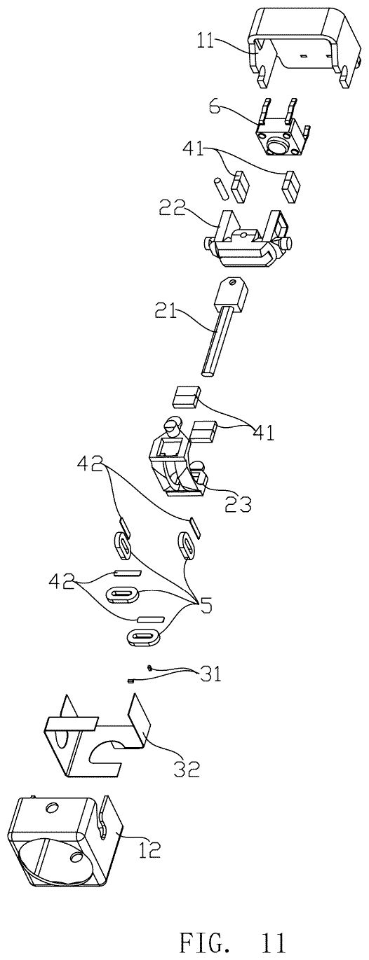

Based on the above embodiment, the present application further discloses another specific implementation. A difference between this embodiment and the above embodiment is as follows: Referring to FIG. 9 to FIG. 11, in this embodiment, the movable component 2 includes a main shaft 21, a secondary shaft 22, and a guide part 23. The secondary shaft 22 and the guide part 23 are respectively arranged in the accommodating chamber formed by the bottom shell 11 and the upper shell 12, and the secondary shaft 22 and the guide part 23 are arranged in sequence in a height extension direction of the shell 1. The secondary shaft 22 is movably connected to the upper shell 12, and the guide part 23 is movably connected to the upper shell 12. One end of the main shaft 21 is connected to the secondary shaft 22, and the other end of the main shaft 21 passes through the secondary shaft 22 and the guide part 23 in sequence and is threaded out of the upper shell 12. The magnets 42 are arranged on the inner wall of upper shell 12, and the circuit board 32 is arranged on the inner wall of the upper shell 12 and covers the magnet sheets 42. The position detection element 31 and the coil are connected to the circuit board 32 and are located on one side of the circuit board 32 facing away from the magnet sheets 42. The magnets 41 are arranged on the secondary shaft 22 and the guide part 23, and positions of the magnets 41 are in one-to-one correspondence to positions of the magnet sheets 42. The magnets 41 and the magnet sheets 42 can attract each other, and the coil 5 is located between the magnets 41 and the magnet sheets 42.

In this embodiment, the switch element 6 is located in the accommodating chamber, and the secondary shaft 22 is located above the switch element 6. In this embodiment, the switch element 6 is arranged in the accommodating chamber, so that the overall volume of the lever 100 can be reduced.

When a user operates the main shaft 21 to move in left, right, front, and rear directions, the main shaft 21 can drive the secondary shaft 22 to move in the left and right directions, or the main shaft 21 can drive the guide part 23 to move in the front and rear directions, thereby driving the magnet 41 to move in all the directions. In this case, the position detection element 31 can detect a moving direction of the magnet 41, and then convert the moving direction of the magnet 41 into a corresponding control signal through the circuit board 32 and transmit the control signal to external equipment (such as a computer). Meanwhile, when required, the main shaft 21 can be pushed, and a force on the main shaft 21 is transmitted to the switch element 6 through the secondary shaft 22, so that the switch element 6 outputs the corresponding signal under the force. In addition, electric energy can be provided to the coil 5 through a voice coil motor, so that the coil 5 can generate the Lorentz force on the magnet 41, namely, generate a reaction force on the moving part 24. The reaction force can be transmitted through the secondary shaft 22 and the guide part 23.

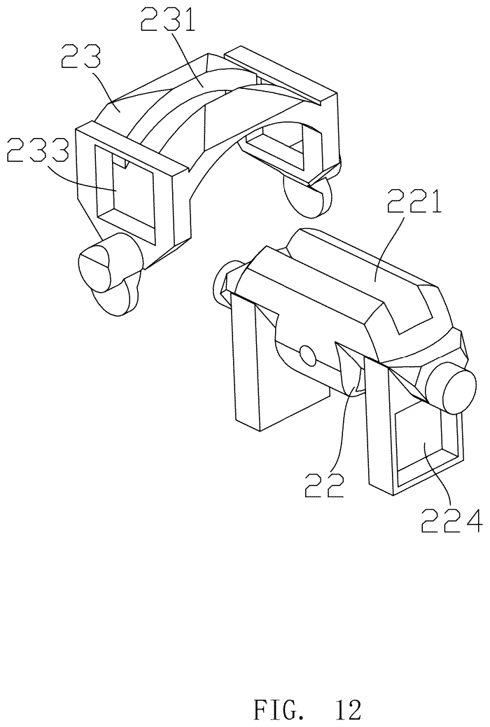

Referring to FIG. 12, first receiving chambers 224 are respectively provided in two ends of the secondary shaft 22, and second receiving chambers 233 are respectively provided in two ends of the guide part 23. A plurality of magnets 41 are provided. The plurality of magnets 41 are respectively accommodated in the first receiving chambers 224 and the second receiving chambers 233.

This embodiment can reset the main shaft 21 by using the mutual attraction between the magnets 41 and the magnet sheets 42, instead of using a physical spring, so that the problem of damage to the physical spring caused by vibration and a falling impact of the movable component can be eliminated, and the life of the lever can be prolonged.

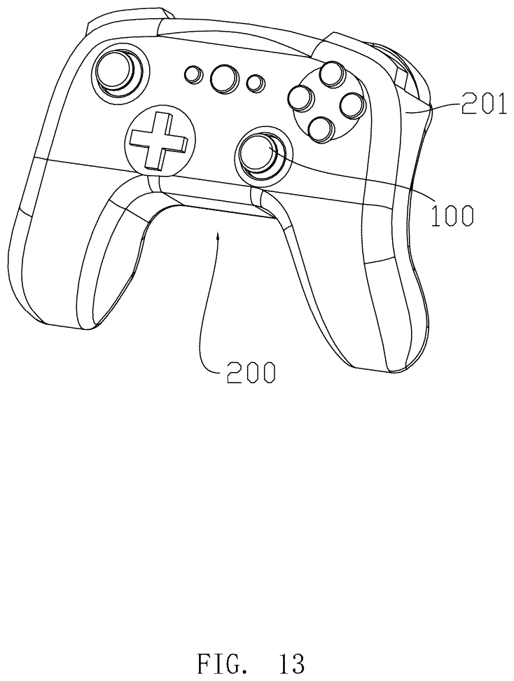

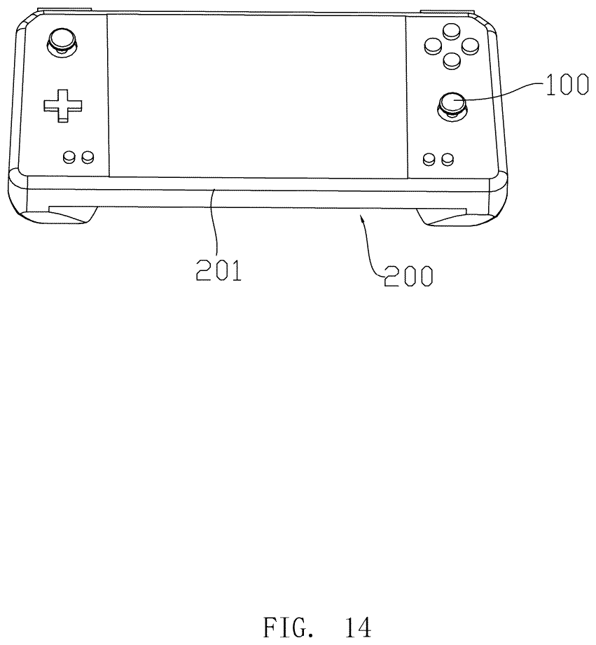

Correspondingly, referring to FIG. 13 and FIG. 14, the present application further discloses an input device 200. The input device 200 includes a device body 201 and the lever 100 as described in any of the above embodiments. The lever 100 is mounted on the device body 201. The input device 200 can be a controller or a portable information machine.

The above is only the preferred embodiments of the present disclosure, and is not intended to limit the present disclosure. Any modifications, equivalent replacements and improvements that are made within the spirit and principle of the present disclosure shall fall within the protection scope of the present disclosure.

What is claimed is:

1. A lever, comprising:
a shell, wherein the shell is provided with an accommodating chamber;
a movable component, wherein the movable component is arranged in the accommodating chamber and is partially threaded out of the shell;
a position detection component, wherein the position detection component is arranged in the accommodating chamber and is configured to: detect displacement information of the movable component and output a corresponding first control signal; and
a magnetic reset component, wherein the magnetic reset component comprises a first magnetic attraction member and a second magnetic attraction member; one of the first magnetic attraction member and the second magnetic attraction member is arranged in the shell; the other one of the first magnetic attraction member and the second magnetic attraction member is arranged in the movable component; and the first magnetic attraction member and the second magnetic attraction member are able to attract each other.

2. The lever according to claim 1, wherein the first magnetic attraction component is a magnet, and the second magnetic attraction component is a magnet sheet.

3. The lever according to claim 2, wherein the position detection component comprises a position detection element and a circuit board; the circuit board is arranged in the accommodating chamber and is partially threaded out of the shell; the position detection element is connected to the circuit board; the position detection element is configured to detect the displacement information of the movable component; and the circuit board is configured to convert the displacement information into the first control signal and output the first control signal.

4. The lever according to claim 3, further comprising a coil, wherein the coil is connected to the circuit board and is located between the first magnetic attraction member and the second magnetic attraction member.

5. The lever according to claim 4, wherein the magnet sheet is arranged on an inner wall of the shell; the circuit board is arranged on the shell and covers the magnet sheet; the position detection element and the coil are located on one side of the circuit board facing away from the magnet sheet; and the magnet is arranged on the movable component.

6. The lever according to claim 5, wherein the shell comprises a bottom shell and an upper shell; the upper shell and the bottom shell are connected to form the accommodating chamber;
the lever further comprises a switch element; the switch element is arranged on the bottom shell; the movable component is rotatably connected to the upper shell, and the movable component cooperates with the switch element; and the switch element is configured to output a second control signal when the movable component pushes the switch element.

7. The lever according to claim 6, wherein the movable component comprises a moving part, a main shaft, a secondary shaft, and a guide part; the moving part is movably arranged in the accommodating chamber;
the secondary shaft and the guide part are respectively arranged in the accommodating chamber, and the secondary shaft is movably connected to the moving part and the upper shell respectively; the guide part is movably connected to the moving part and the upper shell respectively;
one end of the main shaft is connected to the secondary shaft, and the other end of the main shaft passes through the secondary shaft and the guide part in sequence and is threaded out of the upper shell;
the magnet sheet and the circuit board are respectively arranged on an inner wall of the bottom shell; and the magnet is arranged on the moving part.

8. The lever according to claim 7, wherein the bottom shell is provided with a first receiving slot; the magnet sheet is arranged in the first receiving slot; the moving part is provided with a second receiving slot on one side facing the circuit board; and the magnet is arranged in the second receiving slot.

9. The lever according to claim 7, wherein the bottom shell is provided with a plurality of first limiting slots; the movable component further comprises a plurality of bearings; the plurality of bearings are respectively arranged in the plurality of first limiting slots; and a lower surface of the moving part is in contact with the plurality of bearings.

10. The lever according to claim 7, wherein the switch element is located on an outer side of the accommodating chamber; and the secondary shaft is partially threaded out of the outer side of the accommodating chamber and is located above the switch element.

11. The lever according to claim 6, wherein the movable component comprises a main shaft, a secondary shaft, and a guide part; the secondary shaft and the guide part are respectively arranged in the accommodating chamber, and the secondary shaft is movably connected to the upper shell; the guide part is movably connected to the upper shell;
one end of the main shaft is connected to the secondary shaft, and the other end of the main shaft passes through the secondary shaft and the guide part in sequence and is threaded out of the upper shell;
the magnet sheet and the circuit board are respectively arranged on an inner wall of the upper shell; and the magnet is arranged on the secondary shaft and the guide part.

12. The lever according to claim 11, wherein the secondary shaft is provided with a first receiving chamber; the guide part is provided with a second receiving chamber; the magnet is accommodated in the first receiving chamber and the second receiving chamber.

13. The lever according to claim 11, wherein the switch element is located in the accommodating chamber, and the secondary shaft is located above the switch element.

14. The lever according to claim 6, wherein the secondary shaft is provided with a first guide slot; the guide part is provided with a second guide slot; the first guide slot and the second guide slot are arranged crosswise; one end of the main shaft is connected to the secondary shaft, and the other end of the main shaft is threaded out of the upper shell after passing through the first guide slot and the second guide slot in sequence.

15. An input device, comprising a device body and a lever according to claim 1, wherein the lever is mounted on the device body.
